(19) United States
(12) Patent Application Publication
(10) Pub. No.: US 2008/0187308 A1
(43) Pub. Date: Aug. 7, 2008

(54) Hand held self video device

(76) Inventor: Gerald J. Hannan, San Rafael, CA (US)

Correspondence Address: GERALD HANNAN, 107 ALMOND COURT, SAN RAFAEL., CA, 94903, US

(21) Appl. No.: 11/702,384

(22) Filed: Feb. 6, 2007

(51) Int. Cl. G03B 17/00

(52) U.S. Cl. 396/425

(57) ABSTRACT

Prior to this invention there has been no hand held device using a lightweight camera to mimic the services of a photographer for the purpose of an individual to video oneself and one's surroundings. The Hand Held Self Video Device is hand-held and therefore follows the user, keeping the user in view as he or she moves about. It consists of an extendable pole with a camera mount on one end and a remote control on the hand held other end. The camera mount is angled so that the pole and users hand is just outside of the camera's field of view. The user is able to film his or her self with a camera that is several feet away. This gives the impression that there is another person operating the moving camera. Ideal for high, low and tilted camera angles too.

### SUMMARY OF THE INVENTION

This invention arose as a result of a lack in the prior art for a hand held extendable pole with a camera attachment that holds a camera facing the user for the purpose of taking video and still photographs of ones self and others and the environment.

The unique feature of this invention is that camera is angled so that the hand held pole and the user's hand is never in the camera field of view.

Inexpensive to manufacture and lightweight to carry makes it a boon to the amateur photographer.

The user can take close-ups and long shots by manipulating the pole or by using a remote control which can be mounted on the pole within easy reach of the fingers.

The user can take pictures of himself or herself walking with the pole extended in front or behind him or her and in many different angles giving the impression that it is a photographer and not himself or herself that is taking the pictures.

Overhead stills and action films heretofore made possible only with elaborate equipment is a simple matter with this invention.

Another unique feature is a hand grip, ridge or serrations on the user end or on the full length of the pole that makes the user aware at all times without looking, what the attitude or angle of the camera is on the far end of the pole.

For example if the user is holding the pole behind him he will know without looking back when he has the camera in the upright position.

Another feature of this invention is no matter where the user points the pole the camera is always pointed in his direction.

Many other benefits not discussed in this disclosure will become evident as the user practices with the unit.

### Hand Held Self Video Device

### NAMING PARTS

### FIG. 1

(1) Pole with alignment serrations.
(2) Compression clamp collar for pole extension
(3) Camera mounting bracket
(4) Digital camera, not shown
(5) Mount for a remote control

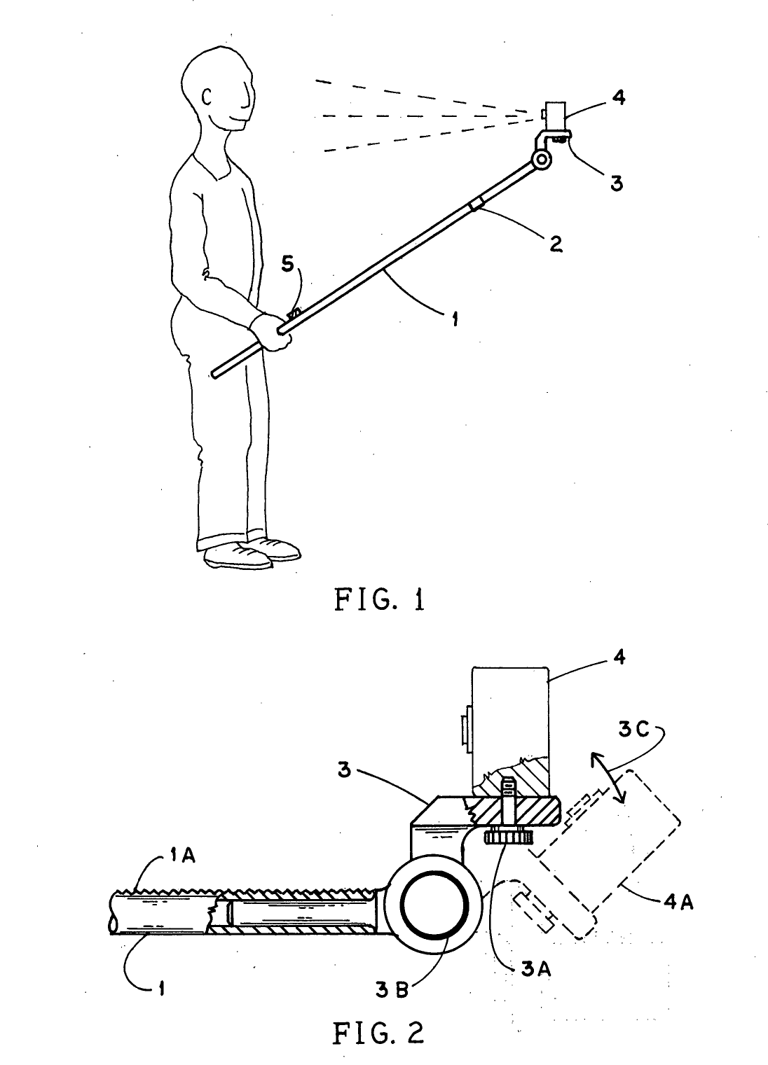

### FIG. 2

(1) Rod with alignment serrations
(2) Camera mounting bracket assembly
(3a) “Universal” camera mounting thumb screw
(3b) Bracket clamp thumb screw
(3c) Camera travel angle
(3) Digital camera (not in patent)

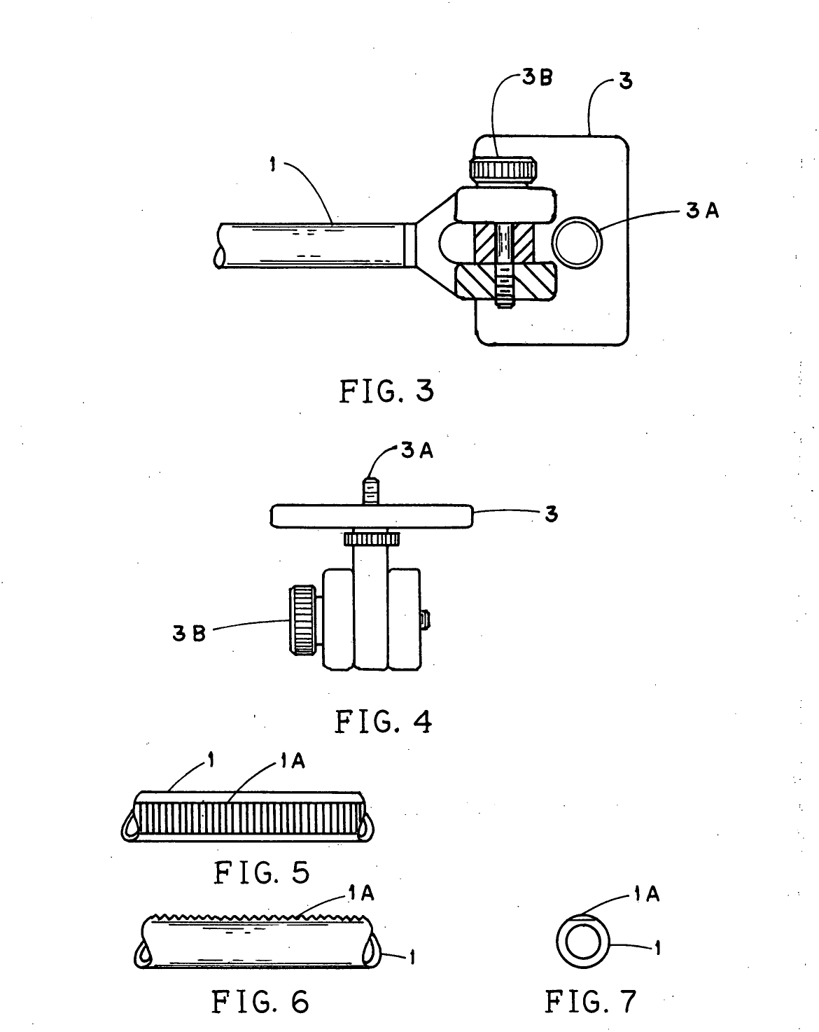

### FIG. 3

(1) Rod with alignment serrations
(2) Camera mounting bracket assembly
(3a) “Universal” camera mounting thumb screw
(3b) Camera bracket clamping thumb screw

### FIG. 4

(3) Camera mounting bracket
(3a) “Universal” camera mounting thumb screw
(3b) Bracket clamp thumb screw

### FIG. 5

(1) Pole with align serrations
(1a) Alignment serrations in line with the camera mount

### FIG. 6

(1) Pole
(1a) Pole align serrations

### FIG. 7

(1) Pole
(1a) Alignment serrations

### DETAILED DESCRIPTION OF THE INVENTION

In carrying out my invention I will describe the construction and operation of the Hand Held Self Video Device.

FIG. 1 The extendable pole (1) is preferably 36 inches long and has a compression clamp collar (2) and can be extended preferably to 72 inches or so. While only one compression clamp collar is shown in the drawing, multiple compression rings and extensions can be used to obtain optimum length.

The mounting bracket assembly (3) is attached to the pole at one end and a mount (5) for a remote control is attached to the pole near its other end and close to the users fingers and hand grip.

A camera (4) aimed in the direction of the user is shown mounted on the camera mounting bracket (3).

In use this Hand Held Video Devise in combination with a remote control allows the user to take videos of him self and his environment while engaged in numerous activities such as walking, running, singing, and interviewing people and other activities too numerous to mention. Without the services of a photographer.

FIG. 2 shows a detailed drawing of the camera mounting bracket (3) on the end of the pole (1) with alignment serrations (1A) visible on the pole.

Alignment of the camera mounting bracket (3) is locked in place by the locking thumb screw (3B). (3A) is the camera mounting thumb screw that holds the camera (4) secured to the camera mounting bracket (3).

This arrangement allows the user to adjust the camera angle in relation to the pole so that the camera field of view is outside or away from the pole and the hand of the user.

The degree of movement possible by the camera mount (3) is indicated by the arc (3C).

(4A) shows the camera in the fully retarded position.

FIG. 3 is a top view of the assembly and shows the camera mount in more detail. (1) is the pole (3) is the camera mounting bracket (3A) is the camera mount thumb screw and (3B) is the bracket clamp thumb screw.

FIG. 4 is an end view of the camera mounting bracket assembly. (3) is the camera mounting bracket. (3A) is the camera mounting thumb screw and (3B) is the bracket clamp thumb screw.

FIG. 5 is a top view of the pole. (1) is the pole and (1A) is the pole alignment serrations.

FIG. 6 is a side view of the pole. (1) is the pole and (1A) the alignment serrations.

FIG. 7 is an end view of the pole. (1) is the pole and (1A) is the alignment serrations.

What is claimed is:

1. A hand held pole for the purpose of making movies of oneself with an attachment at one end to mount a digital camera, and an attachment near the other end to mount a remote control.

2. A digital camera mounting bracket in combination with a remote control on a hand held pole that points the camera directly at the user

3. A camera mounting bracket at the end of a pole that can be adjusted so that the hand held pole and the users hand are not in the camera field of view when the camera is mounted and running.

4. With reference to claim number one, serrations or other means on a length of the pole and in line with the camera mounting bracket to see or feel the alignment of the camera.

5. With reference to claim number three, a locking nut on the camera mounting bracket to lock the mounting bracket securely to hold the camera at the selected angle facing the holder.
